(19) United States
(12) Patent Application Publication
(10) Pub. No.: US 2010/0281429 A1
(43) Pub. Date: Nov. 4, 2010

(54) METHODS AND APPARATUS FOR CONFIGURING A PRODUCT USING AN ARRAY OF CONFIGURATION SETS

(75) Inventors: Ali Kheiri, San Francisco, CA (US); Erik Abernathy, San Mateo, CA (US); Timothy Handorf, Trevor, WI (US); Prashant Gupta, Deerfield, IL (US)

Correspondence Address: K&L Gates LLP, P.O. Box 1135, CHICAGO, IL, 60690, US

(73) Assignee: BIGMACHINES, INC., Deerfield, IL (US)

(21) Appl. No.: 12/433,549

(22) Filed: Apr. 30, 2009

(51) Int. Cl. G06F 3/048

(52) U.S. Cl. 715/822; 715/810; 715/843; 715/780; 715/835

(57) ABSTRACT

Methods and apparatus for configuring a product using an array of configuration sets is disclosed. A user enters a size attribute indicating how many different versions of an attribute will be selected. The client device then displays multiple copies of a configuration set thereby allowing the user to select each attribute value independent of the other attribute values selected. Once the user's selections are complete, and all of the configuration rules are satisfied, the product may be built in accordance with the selected configuration parameters.

### TECHNICAL FIELD

The present disclosure relates in general to product configuration, and, in particular, to methods and apparatus for configuring a product using array attributes.

### BACKGROUND

Often, products have multiple options. However, those options may not all be compatible with each other. For example, a person may be selecting components for a new personal computer. If the user chooses a certain operating system for the computer, that operating system may require a certain minimum amount of memory and/or CPU speed. Configuration software may be used to assist the user and enforce these rules. However, present systems have certain drawbacks.

More specifically, current configuration systems require designers to encode all of the optional product attributes, including the number of each attribute. However, the number of configurable attributes may not be known at design time.

### SUMMARY

The presently disclosed system solves this problem using array based attributes. More specifically, a client device displays a configuration set that includes a plurality of configuration controls such as drop-down boxes, text input boxes, etc. For example, the user may be configuring a building, and two of the choices for the building may be the elevator button shape and the button color. A user enters a size attribute indicating how many different versions of an attribute will be selected. For example, the building may have a user selectable number of floors, where each floor's buttons have the same options for shape (e.g., round, square, triangular) and the same options for color (e.g., clear, white, green), but each button is individually configurable. The client device then displays multiple configuration sets (e.g., based on the number of floors the user had entered) allowing him/her to select each attribute value independent of the other attribute values selected (e.g., one floor's elevator buttons are green squares while another floor's elevator buttons are clear circles). Once the user's selections are complete, and all of the configuration rules are satisfied, the product may be built in accordance with the selected configuration parameters.

### BRIEF DESCRIPTION OF THE DRAWINGS

FIG. 1 is a high level block diagram of an example communications system.

FIG. 2 is a more detailed block diagram showing one example of a computing device.

FIG. 3 is a flowchart of an example process to configure a product using array attributes.

FIGS. 4-7 are screenshots from an example product configuration software tool that uses array attributes.

### DETAILED DESCRIPTION OF EXEMPLARY EMBODIMENTS

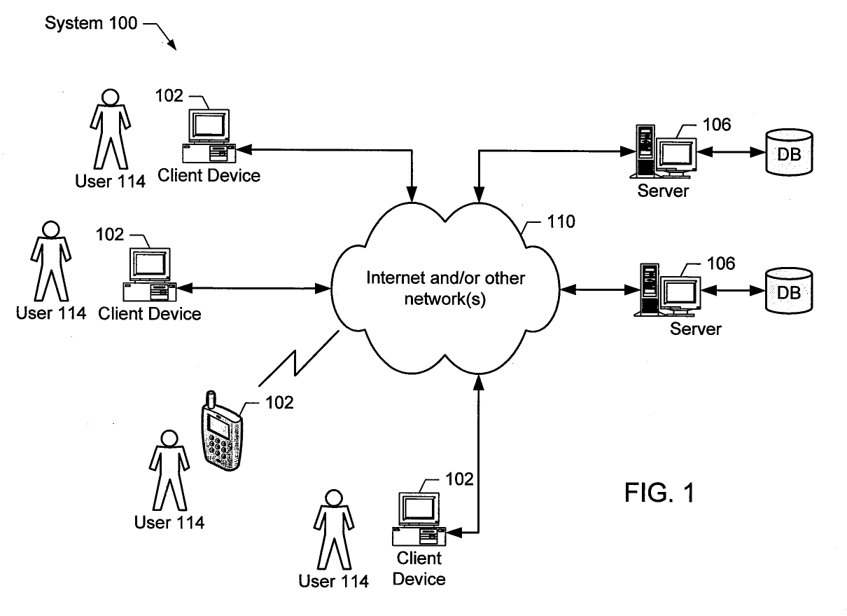

The present system is most readily realized in a network communications system. A high level block diagram of an exemplary network communications system 100 is illustrated in FIG. 1. The illustrated system 100 includes one or more client devices 102, one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

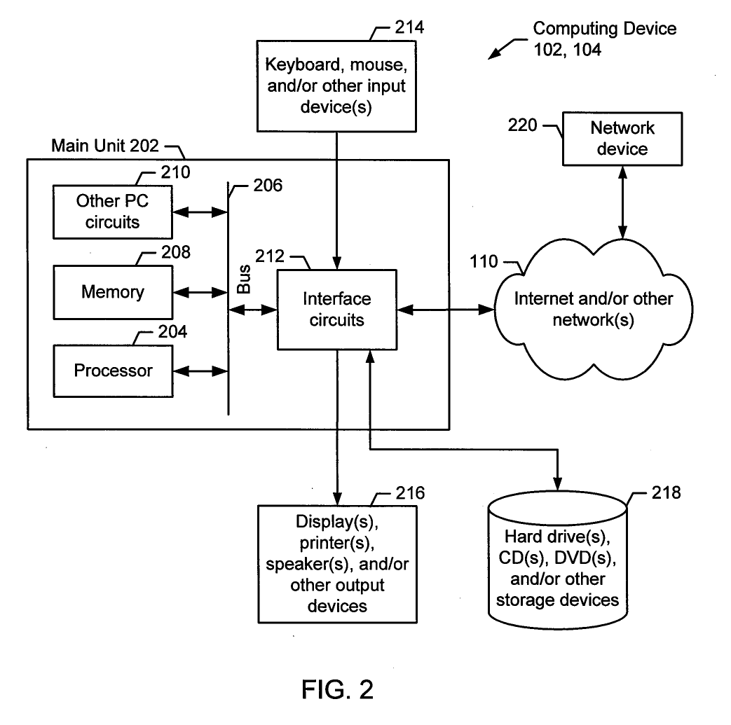

A more detailed block diagram of the electrical systems of a computing device (e.g., client device 102 and/or server 106) is illustrated in FIG. 2. Although the electrical systems of a client device 102 and a typical server 106 may be similar, the structural difference between the two types of devices are well known.

The client device 102 may include a personal computer (PC), a personal digital assistant (PDA), an Internet appliance, a cellular telephone, or any other suitable communication device. The client device 102 includes a main unit 202 which preferably includes one or more processors 204 electrically coupled by an address/data bus 206 to one or more memory devices 208, other computer circuitry 210, and one or more interface circuits 212. The processor 204 may be any suitable processor. The memory 208 preferably includes volatile memory and non-volatile memory. Preferably, the memory 208 stores a software program that interacts with the other devices in the system 100 as described below. This program may be executed by the processor 204 in any suitable manner. The memory 208 may also store digital data indicative of documents, files, programs, web pages, etc. retrieved from a server 106 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the client device 102. For example, the display 216 may be used to display web pages and/or desktop pop-up data received from the server 106. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the client device 102.

The client device 102 may also exchange data with other network devices 220 via a connection to the network 110. The network connection may be any type of network connection, such as an Ethernet connection, digital subscriber line (DSL), telephone line, coaxial cable, etc. Users 114 of the system 100 may be required to register with the server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

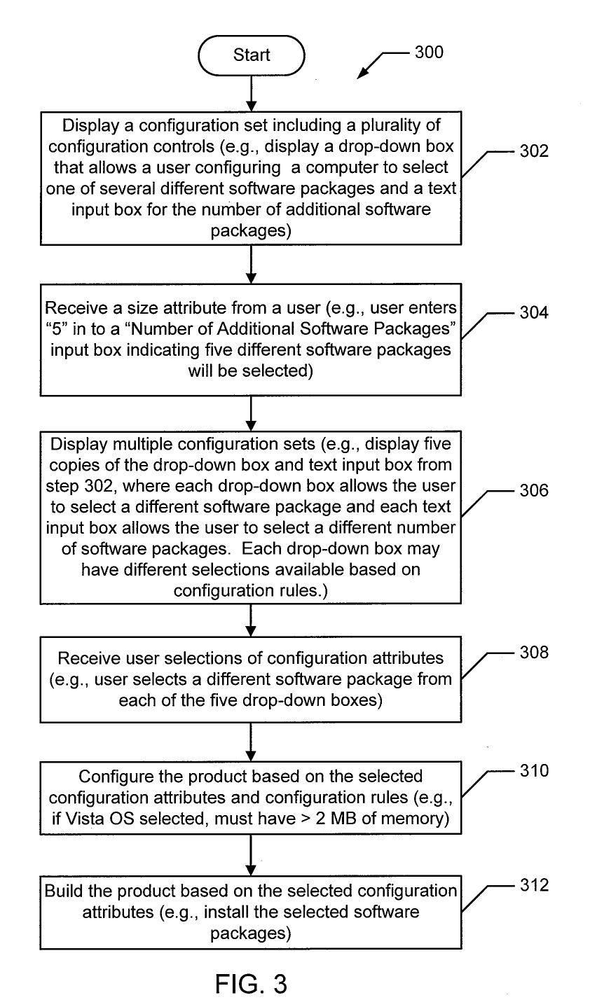

A flowchart of an example process 300 for configuring a product using array attributes is illustrated in FIG. 3. Preferably, the process 300 is embodied in one or more software programs which is stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, and many of the steps described are optional.

In general, the process 300 causes a client device 102 to configure a product using array based attributes. A client device 102 displays a configuration set 402 that includes a plurality of configuration controls 404, 406. For example, one of the controls in the configuration set may be a drop-down box, that includes a plurality of selectable product attributes. Another one of the controls in the configuration set may be a text input box for entering additional product attributes. For example, the user may be configuring a building, and two of the choices for the building may be the elevator button shape and color. A user enters a size attribute indicating how many different versions of an attribute will be selected. For example, the building may have a user selectable number of floors, where each floor's buttons have the same options for shape (e.g., round, square, triangular) and the same options for color (e.g., clear, white, green), but each button is individually configurable. The client device 102 then displays an array of configuration sets allowing the user to select each attribute value independent of the other attribute values selected (e.g., one floor's elevator buttons are button are green squares while another floor's elevator buttons are clear circles). The size of the array and the number of times the array configuration set is shown is controlled by the size attribute (number of floors in this example). The options available and/or selected by default within each configuration set can be controlled and modified through the usage of configuration rules. Once the user's selections are complete, and all of the configuration rules are satisfied, the product may be built in accordance with the selected configuration parameters.

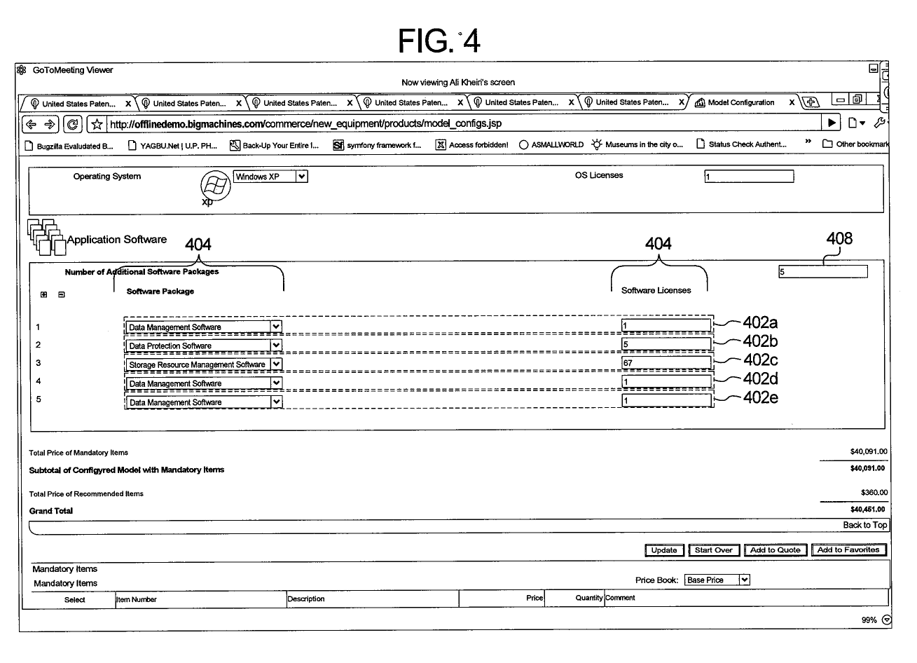

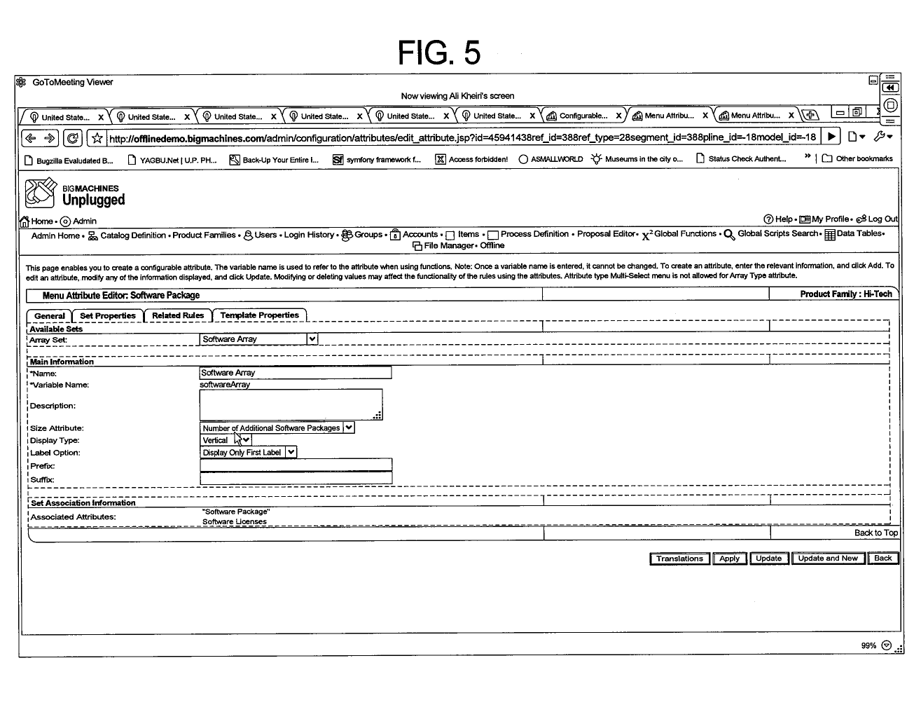

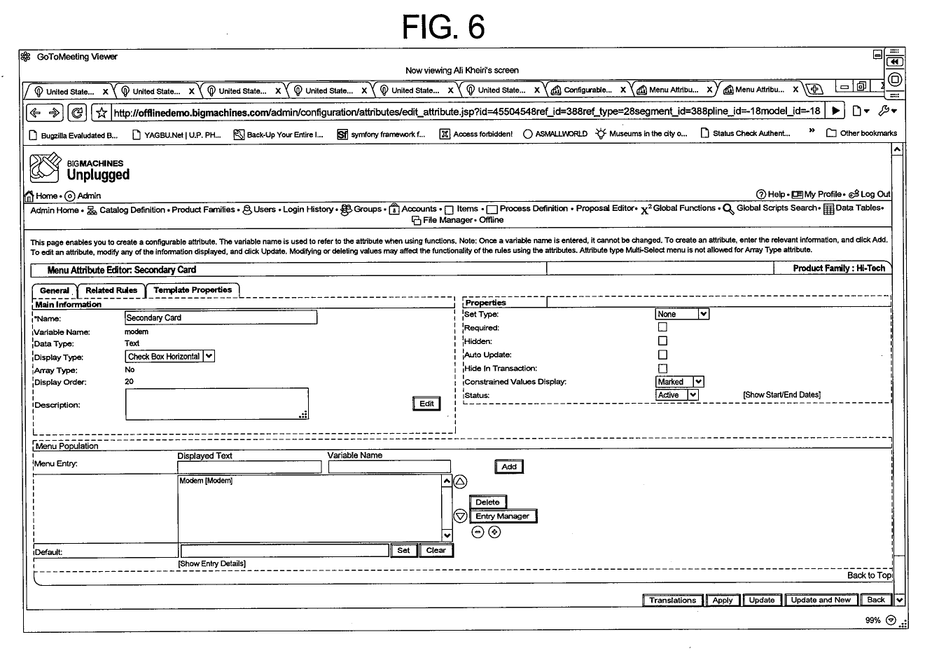

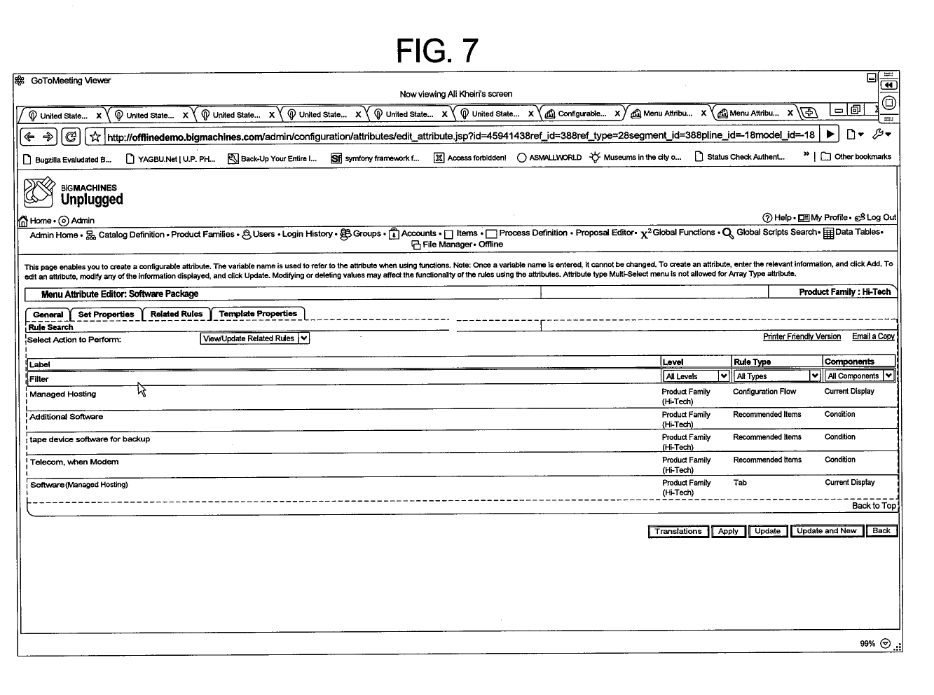

The process 300 preferably begins when a client device 102 displays a configuration set 402a including a plurality of configuration controls (block 302). For example, as shown in the example screen shot 400 of FIG. 4, the client device 102 may display a drop-down box 404 that allows a user configuring a computer to select one of several different software packages and a text input box 406 for the number of additional software packages. Similarly, check boxes, radio buttons, text input boxes, or any other suitable user interface control may be used to select attribute values such as software packages, bike parts, door colors, etc.

Preferably, the client device 102 receives a size attribute from a user 114 (block 304). For example, as shown in FIG. 4, the user 114 may enter the number “5” in to a “Number of Additional Software Packages” text input box 408 indicating five different software packages will be selected. Similarly, drop-down boxes, check boxes, radio buttons, or any other suitable user interface control may be used to enter the size attribute. For example, an icon may be used that increments the value for a size attribute (e.g., by one) when clicked or otherwise activated.

In response to receiving the size attribute, the client device 102 preferably displays a multiple configuration sets (block 306). For example, as shown in FIG. 4, the client device 102 may display five copies 402a-402e of the configuration set 402a from step 302. Preferably, each copy 402a-402e includes the same controls (e.g., drop-down box 404 and text input box 406), wherein each control allows the user 114 to select an attribute value independent of the other attribute values selected (block 308). For example, the user 114 may select different software packages, bike parts, door colors, etc. In the example shown in FIG. 4, the user 114 has selected “Data Management Software” with “1” software license for his/her first software package and “Data Protection Software” with “5” software licenses for his/her second software package.

In some embodiments, the different drop down boxes (or other controls within or outside the configuration sets) may include different selections based on configuration rules. In some instances, a user's input or selection in one configuration control may modify another configuration control. For example, if the user indicates that an elevator door is on the ground floor, the down arrow button color choice may be omitted or dimmed indicating that selecting that value may cause an invalid configuration.

Throughout the above described selection process, the client device 102 preferably guides the user's future choices based on past user choices and a plurality of configuration rules (block 310). A configuration rule may change which configuration attributes are selectable and/or change the values of one or more configuration attributes. For example, if a previously selected software package is incompatible with another software package, one of the software package selections may be dimmed. In another example, one attribute selection may require another attribute selection. For example, one bike part may require another bike part for installation. In such an instance, the client device 102 preferably enforces this relationship for the user 114.

Once the user's selections are complete and the configuration rules are satisfied, the product may be built in accordance with the selected configuration parameters (block 312). For example, the selected software packages may be installed on a computer system, selected bike parts may be assembled in to a bike, etc.

In summary, persons of ordinary skill in the art will readily appreciate that methods and apparatus for configuring a product using array attributes have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of configuring a product, the method comprising:
receiving a value for a size attribute from a user;
causing a displaying of a number of configuration sets on a computer display, the number of sets being based on the value of the size attribute, the configuration sets including a plurality different configuration controls; and
configuring the product based on at least one value associated with the plurality of configuration controls included in the configuration sets.

2. The method of claim 1, wherein configuring the product includes evaluating configuration rules to determine if a plurality of values associated with the plurality of configuration controls are compatible with each other.

3. The method of claim 2, wherein configuring the product includes evaluating the configuration rules to determine if the plurality of values associated with the plurality of configuration controls are compatible with other different configuration control values.

4. The method of claim 1, further comprising modifying a value associated with one of the plurality of configuration controls based on a user selection in another of the plurality of configuration controls.

5. The method of claim 1, further comprising modifying a value associated with one of the plurality of configuration controls based on a user selection outside of the plurality of configuration controls.

6. The method of claim 1, further comprising setting a first value associated with the plurality of configuration controls based on at least one user selection

7. The method of claim 6, further comprising setting a second value associated with the plurality of configuration controls based on the first value associated with the plurality of configuration controls.

8. The method of claim 4, wherein modifying a value associated with one of the plurality of configuration controls includes omitting the value associated with one of the plurality of configuration controls.

9. The method of claim 4, wherein modifying a value associated with one of the plurality of configuration controls includes visually indicating that selecting the value may cause an invalid configuration.

10. The method of claim 4, wherein modifying a value associated with one of the plurality of configuration controls includes changing a visibility of the value associated with one of the plurality of configuration controls.

11. The method of claim 1, wherein the plurality of different configuration controls includes at least one of a drop-down box with a plurality of attribute values, a plurality of check boxes with a plurality of associated attribute values, and a radio button selection control with a plurality of associated attribute values.

12. The method of claim 1, wherein the plurality of different configuration controls includes a text input box.

13. The method of claim 1, wherein receiving the value for the size attribute includes receiving a number via a user interface control.

14. The method of claim 13, wherein the user interface control includes a drop-down box with a plurality of numerical values.

15. The method of claim 13, wherein the user interface control includes a text input box.

16. The method of claim 13, wherein the user interface control includes an icon which increments the value for the size attribute by one when activated.

17. The method of claim 1, wherein displaying the number of configuration sets includes displaying at least one of a plurality of drop-down boxes each with a plurality of common attribute values, a plurality check box groups each with a plurality of common attribute values, and a plurality of radio button groups each with a plurality of common attribute values.

18. The method of claim 1, wherein displaying the number of configuration sets includes displaying a plurality of text input boxes.

19. An apparatus for configuring a product, the apparatus comprising:
a processor;
an input device operatively coupled to the processor;
a user output device operatively coupled to the processor; and
a memory device operatively coupled to the processor, the memory device storing instructions to cause the apparatus to:
receive a value for a size attribute from the input device;
cause a display of a number of configuration sets on the user output device, the number of sets being based on the value of the size attribute, the configuration sets including a plurality different configuration controls; and
configure the product based on at least one value associated with the plurality of configuration controls included in the configuration sets.

20. The apparatus of claim 19, wherein configuring the product includes evaluating configuration rules to determine if a plurality of values associated with the plurality of configuration controls are compatible with each other.

21. The apparatus of claim 20, wherein configuring the product includes evaluating the configuration rules to determine if the plurality of values associated with the plurality of configuration controls are compatible with other different configuration control values.

22. The apparatus of claim 19, wherein the instructions cause the apparatus to modify a value associated with one of the plurality of configuration controls based on a user selection in another of the plurality of configuration controls.

23. The apparatus of claim 19, wherein the instructions cause the apparatus to modify a value associated with one of the plurality of configuration controls based on a user selection outside of the plurality of configuration controls.

24. The apparatus of claim 19, wherein the instructions cause the apparatus to set a first value associated with the plurality of configuration controls based on at least one user selection.

25. The apparatus of claim 24, wherein the instructions cause the apparatus to set a second value associated with the plurality of configuration controls based on the first value associated with the plurality of configuration controls.

26. The apparatus of claim 22, wherein modifying a value associated with one of the plurality of configuration controls includes omitting the value associated with one of the plurality of configuration controls.

27. The apparatus of claim 22, wherein modifying a value associated with one of the plurality of configuration controls includes visually indicating that selecting the value may cause an invalid configuration.

28. The apparatus of claim 22, wherein modifying a value associated with one of the plurality of configuration controls includes changing a visibility of the value associated with one of the plurality of configuration controls.

29. The apparatus of claim 19, wherein the plurality of different configuration controls includes at least one of a drop-down box with a plurality of attribute values, a plurality of check boxes with a plurality of associated attribute values, and a radio button selection control with a plurality of associated attribute values.

30. The apparatus of claim 19, wherein the plurality of different configuration controls includes a text input box.

31. The apparatus of claim 19, wherein receiving the value for the size attribute includes receiving a number via a user interface control.

32. The apparatus of claim 31, wherein the user interface control includes a drop-down box with a plurality of numerical values.

33. The apparatus of claim 31, wherein the user interface control includes a text input box.

34. The apparatus of claim 31, wherein the user interface control includes an icon which increments the value for the size attribute by one when activated.

35. The apparatus of claim 19, wherein displaying the number of configuration sets includes displaying at least one of a plurality of drop-down boxes each with a plurality of common attribute values, a plurality check box groups each with a plurality of common attribute values, and a plurality of radio button groups each with a plurality of common attribute values.

36. The apparatus of claim 19, wherein displaying the number of configuration sets includes displaying a plurality of text input boxes.

37. A computer readable storage device storing instructions to cause a computing device to:
receive a value for a size attribute from the input device;
cause a display of a number of configuration sets on the user output device, the number of sets being based on the value of the size attribute, the configuration sets including a plurality different configuration controls; and
configure the product based on at least one value associated with the plurality of configuration controls included in the configuration sets.

38. The computer readable storage device of claim 37, wherein configuring the product includes evaluating configuration rules to determine if a plurality of values associated with the plurality of configuration controls are compatible with each other.

39. The computer readable storage device of claim 38, wherein configuring the product includes evaluating the configuration rules to determine if the plurality of values associated with the plurality of configuration controls are compatible with other different configuration control values.

40. The computer readable storage device of claim 37, wherein the instructions cause the computing device to modify a value associated with one of the plurality of configuration controls based on a user selection in another of the plurality of configuration controls.

41. The computer readable storage device of claim 37, wherein the instructions cause the computing device to modify a value associated with one of the plurality of configuration controls based on a user selection outside of the plurality of configuration controls.

42. The computer readable storage device of claim 37, wherein the instructions cause the computing device to set a first value associated with the plurality of configuration controls based on at least one user selection.

43. The computer readable storage device of claim 42, wherein the instructions cause the computing device to set a second value associated with the plurality of configuration controls based on the first value associated with the plurality of configuration controls.

44. The computer readable storage device of claim 40, wherein modifying a value associated with one of the plurality of configuration controls includes omitting the value associated with one of the plurality of configuration controls.

45. The computer readable storage device of claim 40, wherein modifying a value associated with one of the plurality of configuration controls includes visually indicating that selecting the value may cause an invalid configuration.

46. The computer readable storage device of claim 40, wherein modifying a value associated with one of the plurality of configuration controls includes changing a visibility of the value associated with one of the plurality of configuration controls.

47. The computer readable storage device of claim 37, wherein the plurality of different configuration controls includes at least one of a drop-down box with a plurality of attribute values, a plurality of check boxes with a plurality of associated attribute values, and a radio button selection control with a plurality of associated attribute values.

48. The computer readable storage device of claim 37, wherein the plurality of different configuration controls includes a text input box.

49. The computer readable storage device of claim 37, wherein receiving the value for the size attribute includes receiving a number via a user interface control.

50. The computer readable storage device of claim 49, wherein the user interface control includes a drop-down box with a plurality of numerical values.

51. The computer readable storage device of claim 49, wherein the user interface control includes a text input box.

52. The computer readable storage device of claim 49, wherein the user interface control includes an icon which increments the value for the size attribute by one when activated.

53. The computer readable storage device of claim 37, wherein displaying the number of configuration sets includes displaying at least one of a plurality of drop-down boxes each with a plurality of common attribute values, a plurality check box groups each with a plurality of common attribute values, and a plurality of radio button groups each with a plurality of common attribute values.

54. The computer readable storage device of claim 37, wherein displaying the number of configuration sets includes displaying a plurality of text input boxes.
